(19) United States
(12) Patent Application Publication
(10) Pub. No.: US 2026/0045016 A1
(43) Pub. Date: Feb. 12, 2026

(54) SYSTEM AND METHOD FOR DISPLAYING AN IMAGE-BASED REPRESENTATION OF MEASUREMENT DATA

(71) Applicant: Roche Diabetes Care, Inc., Indianapolis, IN (US)

(72) Inventor: Paul Joseph Galley, Cumberland, IN (US)

(21) Appl. No.: 19/365,346

(22) Filed: Oct. 22, 2025

Related U.S. Application Data
(63) Continuation of application No. PCT/US2024/026378, filed on Apr. 26, 2024.
Application No. PCT/US2024/026378 is a continuation of application No. PCT/US2023/066236, filed on Apr. 26, 2023.

(51) Int. Cl. G06T 11/60; G06T 1/60; G06T 7/11; H04M 1/72427

(52) U.S. Cl. CPC G06T 11/60; G06T 1/60; G06T 7/11; H04M 1/72427

(57) ABSTRACT

A method of operating a medical monitoring system includes providing stored program instructions for a software application. The software application is configured to be stored in a non-transitory memory of a computing device. Upon execution by a processor of the computing device, the software application is configured to (i) obtain measurement data, (ii) store image data of a nonmedical image on the non-transitory memory, (iii) modify the image data based on the measurement data to generate modified image data, and (iv) render the modified image data as a modified image on a display screen of the computing device. Modifying the image data includes changing a feature of the nonmedical image to represent the measurement data.

This application claims priority to international patent application no. PCT/US2024/026378,filed on Apr. 26, 2024 in the United States receiving office, which claims priority to international patent application no. PCT/US2023/066236, filed on 26 Apr. 2023 in the United States receiving office, the disclosures of which are incorporated herein by reference in their entirety.

### FIELD

This disclosure relates to a medical monitoring system and a method for displaying an image representing measurement data on an electronic device. The system and the method may be applied to monitoring blood glucose concentration information, blood pressure information, cholesterol level information, and/or coagulation information. The system and the method increase the privacy of the user.

### BACKGROUND

In many fields of medical treatment and healthcare, the monitoring of certain body functions is required. For people with diabetes, a regular check of blood glucose concentration is typically part of the person's daily routine. Preferably, the blood glucose concentration is measured at least several times per day, so that the person can determine when to initiate a responsive medication (such as insulin or an insulin analog) when certain limits are exceeded. In order not to unduly disrupt the daily routine of the person, in many cases a portable medical test device is used. A large number of portable medical test devices for monitoring various body functions are commercially available. These medical test devices provide blood glucose concentration data, for example, in a fast and reliable manner.

Often, people with diabetes check their blood glucose concentration in public settings, such as prior to a business lunch at a restaurant or in the company of people that may or may not know that the person is managing a medical condition. For example, a person using a continuous glucose monitor may open an application or “app” on a smartphone or smartwatch and view a medical image (such as a graph or chart) of plotted blood glucose concentration data. The chart is an effective means of conveying the concentration data to the person; however, often times the chart and the associated graphical interface of the app are easily visible by others as medically-oriented information. As a result, by checking their blood glucose concentration in a public setting, the person may unintentionally or unknowingly share personal medical information with those in their immediate vicinity. Moreover, for some people, the medical chart and the clinical interface of the app are an unwanted reminder that they are managing a serious medical condition.

Based on the above-described deficiencies of currently available medical test devices, it is desirable to improve the management and display of health measurement data to increase user privacy and to improve the user experience.

### SUMMARY

According to an exemplary embodiment, a method of operating a medical monitoring system includes providing stored program instructions for a software application. The software application is configured to be stored in a non-transitory memory of a computing device. Upon execution by a processor of the computing device, the software application is configured to (i) obtain measurement data, (ii) store image data of a nonmedical image on the non-transitory memory, (iii) modify the image data based on the measurement data to generate modified image data, and (iv) render the modified image data as a modified image on a display screen of the computing device. Modifying the image data includes changing a feature of the nonmedical image to represent the measurement data.

According to an aspect of the method, the feature is a horizon, and the measurement data includes measurement values and corresponding time values. Changing the feature includes changing the horizon to represent the measurement values in chronological order according to the time values.

According to another aspect of the method, the measurement values include a prior measurement value and a subsequent measurement value, and changing the feature further includes (i) changing the horizon to decrease a showing of an image portion located on a sky-side of the horizon in response the subsequent measurement value being greater than the prior measurement value, and (ii) changing the horizon to increase the showing of the image portion located on the sky-side of the horizon in response to the subsequent measurement value being less than the prior measurement value.

In another aspect of the method, the nonmedical image depicts a mountain range, and the horizon includes at least one peak of the mountain range and/or at least one valley of the mountain range. Changing the feature of the nonmedical image further includes resizing and/or repositioning the at least one peak and/or the at least one valley to represent the measurement values.

According to a further aspect of the method, the nonmedical image is a selected nonmedical image of a plurality of nonmedical images, and the software application is further configured to (i) store image data of the plurality of nonmedical images in the non-transitory memory, each nonmedical image having a corresponding feature, (ii) determine a feature mathematical function for each feature of the nonmedical images of the plurality of nonmedical images, the feature mathematical function defining a feature curve defined by the corresponding feature, (iii) determine a data mathematical function corresponding to a data curve defined by measurement values of the measurement data, and (iv) compare values of the data mathematical function to values of the image mathematical function using the processor to identify the selected nonmedical image as the nonmedical image of the plurality of nonmedical images having a feature curve that is a best fit to the data curve.

In an aspect of the method, the nonmedical image is a selected nonmedical image of a plurality of nonmedical images, and the software application is further configured to receive input data from a user with an input device of the computing device. The input data identifies the selected nonmedical image.

Another aspect of the method includes receiving input data from a user with an input device of the computing device, the input data corresponding to a selected theme of a plurality of themes stored as theme data in the non-transitory memory. The nonmedical image is a selected nonmedical image of a plurality of nonmedical images. Each nonmedical image is assigned a theme of the plurality of themes, and the theme of the selected nonmedical image matches the selected image theme.

In a further aspect of the method, the software application is configured to obtain overlay data corresponding to a time of day, weather information, and/or critical state information; and to render the overlay data as time of day graphics, weather information graphics, and/or critical state graphics overlaid on the modified image as shown on the display screen.

In yet another aspect of the method, the software application is further configured to generate the modified image data with a machine learning model operating on (i) a processor of a remote server in communication with the computing device, and/or (ii) the processor of the computing device.

According to another aspect of the method, the measurement data includes measurement values and corresponding time values. In this aspect, modifying the image data further includes segmenting the nonmedical image into a plurality of segments, each segment including a portion of the feature, generating a plurality modified segments by changing the portion of the feature of each segment to represent at least one measurement value, and chronologically arranging the modified segments based on the corresponding time values to form the modified image.

In another aspect of the method, the software application is further configured to (i) obtain additional measurement data, (ii) generate an updated modified segment having a portion of the feature that corresponds to a measurement value of the additional measurement data, (iii) append the updated modified segment to the modified image, and (iv) delete image data corresponding to an oldest modified segment from the modified image.

An additional aspect of the method includes rendering the measurement data on the display screen.

According to another exemplary embodiment, a medical monitoring system includes a measurement device, a remote server, and a computing device. The measurement device includes a sensor configured to generate measurement data. The remote server is configured (i) to receive the measurement data, (ii) to store image data of a nonmedical image on a non-transitory memory, and (iii) to modify the image data based on the measurement data to generate modified image data using a processor of the remote server. The computing device is in communication with the remote server and is configured to receive the modified image data. The computing device includes a processor configured to render the modified image data as a modified image on a display screen of the computing device. Modifying the image data includes changing a feature of the nonmedical image to represent the measurement data.

According to an aspect of the medical monitoring system, the measurement device is a body-worn continuous glucose monitor, and the sensor is configured to detect glucose in interstitial fluid. The measurement data is representative of a blood glucose concentration over time.

In another aspect of the medical monitoring system, the computing device is one of a smartphone, a smartwatch, a laptop computer, and a desktop computer.

In another exemplary embodiment, a method of operating a medical monitoring system includes receiving measurement data with a remote server, and generating synthetic image data of a synthetic nonmedical image based on the measurement data with the remote server. The synthetic nonmedical image includes a feature that is representative of the measurement data. The method further includes transmitting the synthetic image data to a computing device for rendering as the synthetic nonmedical image on a display screen of the computing device. The synthetic nonmedical image is generated by a machine learning model operated on the remote server. At least one trend in the measurement data is shown by the feature of the synthetic nonmedical image.

According to an aspect of the method, the feature is a horizon that is representative of the measurement data.

In another aspect, the method includes (i) receiving additional measurement data with the remote server, (ii) generating updated synthetic image data of an updated synthetic nonmedical image portion having an updated feature that is representative of the additional measurement data, and (iii) processing the updated synthetic image data and the synthetic image data with a processor of the remote server or the computing device, such that the updated synthetic nonmedical image portion is appended to the synthetic nonmedical image.

A further aspect of the method includes detecting that the measurement data includes at least one measurement value that is outside of a predefined range with a processor of the computing device or the remoter server, and generating overlay data corresponding to a critical state graphic based on the at least one measurement value for rendering as the critical state graphic overlaid on the synthetic nonmedical on the display screen using a processor of the computing device.

An additional aspect of the method includes generating the measurement data with a body-worn continuous glucose meter, and transmitting the measurement data from the body-worn continuous glucose meter to the remote server using the computing device. The measurement data is representative of a blood glucose concentration over time.

According to a further exemplary embodiment of the disclosure, a method of operating a medical monitoring system includes obtaining measurement data, and storing image data of a nonmedical image on a non-transitory memory device. The method further includes modifying the image data based on the measurement data to generate modified image data, and rendering the modified image data as a modified image on a display screen of a computing device using a processor of the computing device. Modifying the image data includes changing a feature of the nonmedical image to represent the measurement data.

According to yet another exemplary embodiment of the disclosure, a method of operating a medical monitoring system includes obtaining measurement data with a remote server, and generating image data of a synthetic nonmedical image based on the measurement data with the remote server. The synthetic nonmedical image includes a feature that is representative of the measurement data. The method further includes transmitting the image data to a computing device, and rendering the image data as the synthetic nonmedical image on a display screen of the computing device. The synthetic nonmedical image is generated by a machine learning model operated on the remote server. At least one trend in the measurement data is shown by the feature of the synthetic nonmedical image.

According to a further exemplary embodiment of the disclosure, a method of operating a medical monitoring system includes receiving measurement data, storing image data of a nonmedical image on a non-transitory memory device, modifying the image data based on the measurement data to generate modified image data, and transmitting the modified image data as a modified image for rendering on a display screen of a computing device using a processor of the computing device. Modifying the image data includes changing a feature of the nonmedical image to represent the measurement data.

In yet another exemplary embodiment of the disclosure, a method of operating a medical monitoring system includes providing stored program instructions for a software application. The software application is configured to be stored in a non-transitory memory of a computing device. Upon execution by a processor of the computing device, the software application is configured to receive measurement data with a remote server, and generate synthetic image data of a synthetic nonmedical image based on the measurement data with the remote server. The synthetic nonmedical image includes a feature that is representative of the measurement data. The software application is further configured to transmit the synthetic image data to a computing device for rendering as the synthetic nonmedical image on a display screen of the computing device. The synthetic nonmedical image is generated by a machine learning model operated on the remote server. At least one trend in the measurement data is shown by the feature of the synthetic nonmedical image.

### BRIEF DESCRIPTION OF THE FIGURES

The above-described features and advantages, as well as others, should become more readily apparent to those of ordinary skill in the art by reference to the following detailed description and the accompanying figures in which:

FIG. 1 illustrates a computing device (shown as a smartphone) of a medical monitoring system, as disclosed herein, the computing device has a display screen showing a modified image that represents a person's measurement data, such as blood glucose concentration;

FIG. 2 is a block diagram of the medical monitoring system that includes the computing device of FIG. 1, the medical monitoring system further includes a measurement device and a remote server;

FIG. 3 is a flowchart depicting an exemplary method of operating the medical monitoring system of FIG. 2;

FIG. 4 depicts a unmodified nonmedical image that is suitable to be modified to represent the measurement data from the measurement device;

FIG. 5 depicts a modified image based on the nonmedical image of FIG. 4, the modified image includes a feature that represents the measurement data from the measurement device;

FIG. 6 is a flowchart depicting another exemplary method of operating the medical monitoring system of FIG. 2; and

FIG. 7 is a synthetic nonmedical image generated by a machine learning model according to the method depicted by the flowchart of FIG. 6.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that this disclosure includes any alterations and modifications to the illustrated embodiments and includes further applications of the principles of the disclosure as would normally occur to one skilled in the art to which this disclosure pertains.

Aspects of the disclosure are disclosed in the accompanying description. Alternate embodiments of the disclosure and their equivalents may be devised without parting from the spirit or scope of the disclosure. It should be noted that any discussion herein regarding “one embodiment,” “an embodiment,” “an exemplary embodiment,” and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

For the purposes of the disclosure, the phrase “A and/or B” means (A), (B), or (A and B). For the purposes of the disclosure, the phrase “A, B, and/or C” means (A), (B), (C), (A and B), (A and C), (B and C), or (A, B and C).

The terms “comprising,” “including,” “having,” and the like, as used with respect to embodiments of the disclosure, are synonymous.

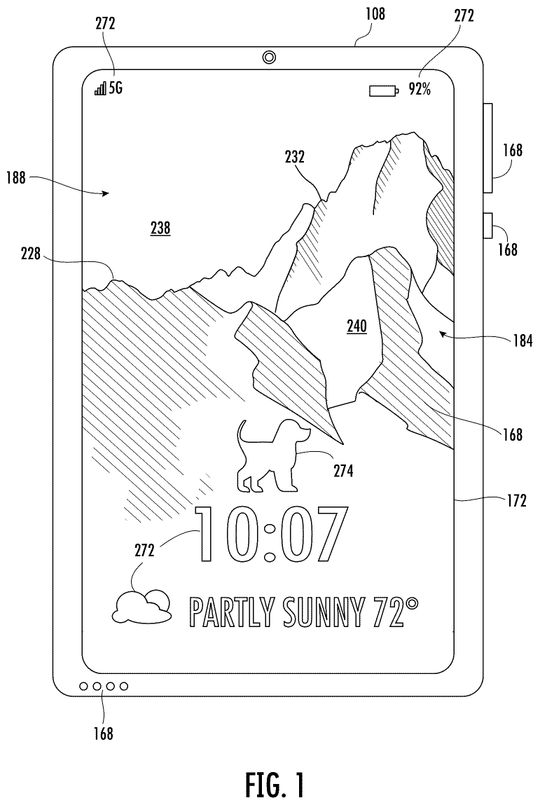

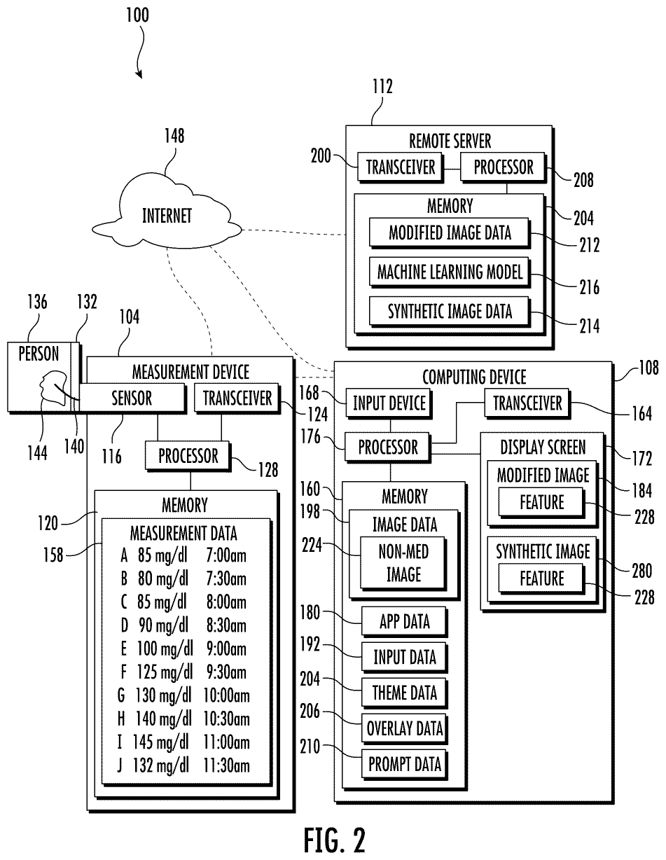

As shown in FIG. 1, an exemplary computing device 108 includes a display screen 172 showing a graphical user interface (“GUI”) 188. The GUI 188 includes an image of a mountain range, the time of day, and certain other data overlaid there upon. To the uninitiated, the GUI 188 is a wallpaper, homescreen, or background scene of the computing device 108, which is shown as a smartphone. As such, when viewed by a third party, the user of the computing device 108 appears to be checking the time or checking for notifications. To the user, however, the GUI 188 conveys blood glucose concentration data 158 (FIG. 2) in a nonmedical, motivational, and disguised format. Specifically, the user's blood glucose concentration data or other measurement data 158 is encoded into a modified image 184 and corresponds to the illustrated horizon 232. As a result, the user can check her measurement data 158 in public without others knowing that she is managing a medical condition. Moreover, the user is provided with the measurement data 158 in the form of a nonmedical scene that improves the user experience by being less likely to directly remind the user of their medical condition. Below, each aspect of a medical monitoring system 100 that includes the computing device 108 is described, including methods 300, 600 for encoding the measurement data 158 into an image.

With reference to FIG. 2, the medical monitoring system 100 includes a measurement device 104, the computing device 108, and a remote server 112. In one embodiment, the measurement device 104 is a body-worn continuous glucose monitor (“CGM”) that is used to generate the measurement data 158 that corresponds to a person's blood glucose concentration. The measurement device 104 includes a sensor 116, a memory device 120, and a transceiver 124 each operably connected to a processor 128.

The sensor 116 is mounted on the skin 132 of a person 136 with an adhesive and includes a probe 140 that is positioned just under the skin 132. The probe 140 is in contact with interstitial fluid 144 of the person 136. In one embodiment, the probe 140 is an enzyme-based amperometric biosensor that is configured to measure glucose concentrations in the interstitial fluid 144. In other embodiments, the sensor 116 measures glucose concentrations according to other suitable structural configurations and methodologies. The measurement device 104 may operate with or without a corresponding insulin pump (not shown).

The processor 128 of the measurement device 104 is configured to execute instructions to operate the measurement device 104 to enable the features, functionality, characteristics, and/or the like as described herein. The processor 128 generally comprises one or more processors which may operate in parallel or otherwise in concert with one another. It will be recognized by those of ordinary skill in the art that the term “processor” as used herein includes any hardware system, hardware mechanism, or hardware component that processes data, signals, or other information. Accordingly, the processor 128 may include a system with a central processing unit, graphics processing units, multiple processing units, dedicated circuitry for achieving functionality, programmable logic, or other processing systems.

As shown in FIG. 2, the memory device 120 is configured to store data and program instructions that, when executed by the processor 128, enable the measurement device 104 to perform various operations described herein. The memory device 120 may be any type of electronic device capable of storing information accessible by the processor 128, such as a memory card, read only memory (“ROM”), random access memory (“RAM”), a hard drive, a solid state drive, a disc, flash memory, or any of various other computer-readable media serving as data storage devices, as will be recognized by those of ordinary skill in the art. The memory device 120 is also referred to herein as a non-transitory computer readable medium, a non-transitory memory device, and a non-transitory memory. The memory device 120 stores the measurement data 158 generated by the processor 128 and as measured by the sensor 116. Exemplary measurement data 158 is shown in FIG. 2 and, for reference, is identified with the letters A-J. The letters A-J are not part of the measurement data 158.

The transceiver 124 of the measurement device 104, in one embodiment, is configured for the wired and/or wireless exchange of data with the computing device 108. The transceiver 124 includes one or more modems, processors, memories, oscillators, antennas, or other hardware conventionally included in a communications module to enable electronic communications with various other devices. For example, the transceiver 124 may exchange electronic data using a wireless local area network (“Wi-Fi”), a personal area network, Bluetooth®, near-field communication (“NFC”), ultra-wide band (“UWB”), a cellular network, and/or any other wireless network protocol. Accordingly, the transceiver 124 is compatible with any desired wireless communication standard or protocol including, but not limited to, IEEE 802.11, IEEE 802.15.1 (“Bluetooth®”), Global System for Mobiles (“GSM”), and Code Division Multiple Access (“CDMA”). In one embodiment, the transceiver 124 operably connects the measurement device 104 to the Internet 148 for data exchange with any other Internet 148 connected device. In another embodiment, the transceiver 124 transmits and receives data directly from the computing device 108 without being connected to the Internet 148. The transceiver 124 is also referred to herein as a network adapter, a network device, and/or a network communication module.

With continued reference to FIG. 2, the computing device 108 of the medical monitoring system 100 includes a memory device 160, a transceiver 164, an input device 168, and a display screen 172 each operably connected to a processor 176. The computing device 108 is described and illustrated herein as a smartphone. It will be appreciated that the illustrated embodiment of the computing device 108 is only one exemplary embodiment and is merely representative of any of various manners, configurations, or combinations of a server, a personal computer, a desktop computer, a laptop computer, a smartwatch, a mobile phone, a tablet computer, or any other computing device that is operative in the manner set forth herein.

The processor 176 is configured to execute instructions to operate the computing device 108 to enable the features, functionality, characteristics, and/or the like as described herein. The processor 176 generally comprises one or more processors which may operate in parallel or otherwise in concert with one another. The processor 176 may include a system with a central processing unit, graphics processing units, multiple processing units, dedicated circuitry for achieving functionality, programmable logic, or other processing systems. The processor 176 is configured to run applications (i.e., “apps”) stored as app data 180 in the memory device 160.

As shown in FIG. 2, the memory device 160 is configured to store data and program instructions that, when executed by the processor 176, enable the computing device 108 to perform various operations and methods described herein. The memory device 160 may be any type of electronic device capable of storing information accessible by the processor 176, such as a memory card, ROM, RAM, a hard drive, a solid state drive, a disc, flash memory, or any of various other computer-readable medium serving as data storage devices, as will be recognized by those of ordinary skill in the art. The memory device 160 is also referred to herein as a non-transitory computer readable medium, a non-transitory memory device, and a non-transitory memory. The memory device 160 is configured to store image data 198 of a nonmedical image 224 that is used by the computing device 108 and/or the remote server 112 to generate the modified image 184. Additionally, in at least some embodiments, the memory device 160 stores theme data 202 corresponding to a theme of the nonmedical images 224 of the image data 198; prompt data 210 for providing to the machine learning model 216; and overlay data 206 corresponding to the time of day, smartphone information, and a critical state information.

The transceiver 164, in one embodiment, is configured for the wired and/or wireless exchange of data with the measurement device 104, the remote server 112, and the Internet 148. The transceiver 164 includes one or more modems, processors, memories, oscillators, antennas, or other hardware conventionally included in a communications module to enable electronic communications with various other devices. For example, the transceiver 164 may exchange data using Wi-Fi, a personal area network, Bluetooth®, NFC, UWB, a cellular network, and/or any other wireless network protocol. Accordingly, the transceiver 164 is compatible with any desired wireless communication standard or protocol including, but not limited to, IEEE 802.11, Bluetooth®”, GSM, and CDMA. The transceiver 164 operably connects the computing device 108 to the Internet 148 for data exchange with any other Internet 148 connected device. Additionally, the transceiver 164 transmits and receives data from the measurement device 104 either directly or indirectly. The transceiver 164 is also referred to herein as a network adapter and/or a network device.

The display screen 172 of the computing device 108 is configured to render and to display text, images, and other user sensible outputs and visually comprehensible data including the modified image 184 of FIG. 1 that encodes the measurement data 158. The display screen 172 may comprise any of various known types of displays, such as liquid crystal displays (“LCD”) or organic light emitting diode (“OLED”) screens, configured to display the GUI 188 and/or the modified image 184, as described herein.

With reference again to FIG. 1, the input device 168 of the computing device 108 is a touchscreen applied over the display screen 172 that is configured to respond to the touch of a finger or a stylus by generating user input data 192 (FIG. 2). The input device 168 may also include at least one button, switch, keyboard, and/or keypad that is configured to generate the input data 192 when touched or moved by a user. Additionally or alternatively, the input device 168 includes a microphone configured to generate the input data 192 in response to sounds, such as the voice of a user of the computing device 108. In yet another embodiment, the input device 168 is any device configured to generate the input data 192, as recognized by those of ordinary skill in the art.

As shown in FIG. 2, the remote server 112 of the medical monitoring system 100 includes a transceiver 200 and a memory device 204 operably connected to a processor 208.

The processor 208 is configured to execute instructions to operate the remote server 112 to enable the features, functionality, characteristics and/or the like as described herein. The processor 208 generally comprises one or more processors which may operate in parallel or otherwise in concert with one another. The processor 208 may include a system with a central processing unit, graphics processing units, multiple processing units, dedicated circuitry for achieving functionality, programmable logic, or other processing systems.

The transceiver 200, in one embodiment, is configured for the wired and/or wireless exchange of data with the computing device 108 and the Internet 148. The transceiver 200 includes one or more modems, processors, memories, oscillators, antennas, or other hardware conventionally included in a communications module to enable electronic communications with various other devices. For example, the transceiver 200 may exchange data using Wi-Fi, a personal area network, Bluetooth®, NFC, UWB, a cellular network, and/or any other wireless network protocol. Accordingly, the transceiver 200 is compatible with any desired wireless communication standard or protocol including, but not limited to IEEE 802.11, Bluetooth®, GSM, and CDMA. The transceiver 200 is also referred to herein as a network adapter and/or a network device.

The memory device 204 is configured to store data and program instructions that, when executed by the processor 208, enable the remote server 112 to perform various operations and methods described herein. The memory device 204 may be of any type of electronic device capable of storing information accessible by the processor 208, such as a memory card, ROM, RAM, hard drives, solid state drives, discs, flash memory, or any of various other computer-readable medium serving as data storage devices, as will be recognized by those of ordinary skill in the art. The memory device 204 is also referred to herein as a non-transitory computer readable medium, a non-transitory memory device, and a non-transitory memory. The remote server 112 is configured to store modified image data 212 corresponding to the modified image 184, and, in some embodiments, synthetic image data 214 generated by a machine learning model 216.

As shown in FIG. 2, the machine learning model 216 of the remote server 112 is a text-to-image model that is configured to receive natural language descriptions and numeral inputs (i.e., prompts, prompt data 210). The machine learning model 216 may be characterized as an artificial neural network (“ANN”) or a simulated neural network (“SNN”). In one embodiment, the machine learning model 216 generates new images that accurately represent the prompt, and which encode or represent the measurement data 158. The new image is saved in the memory 112 as the synthetic image data 214 of a synthetic nonmedical image 280. In another embodiment, the machine learning model 212 modifies an existing nonmedical image 224 stored as the image data 198 based on the measurement data 158 to arrive at the modified image data 212.

The machine learning model 216 is trained with training data including millions of images and millions of corresponding text-based descriptions. Exemplary machine learning models 216 suitable to generate the modified image data 212 and/or the synthetic image data 214 have been developed by OpenAI, Stable Diffusion, and Midjourney which include DALL-E and DALL-E 2. DALL-E and DALL-E 2 are trained generative pre-trained transformer 3 (“GPT-3”) language models that translate text into images using deep learning. The machine learning model 216, in some embodiments, is referred as an artificial intelligence (“AI”) art generator or an AI image generator.

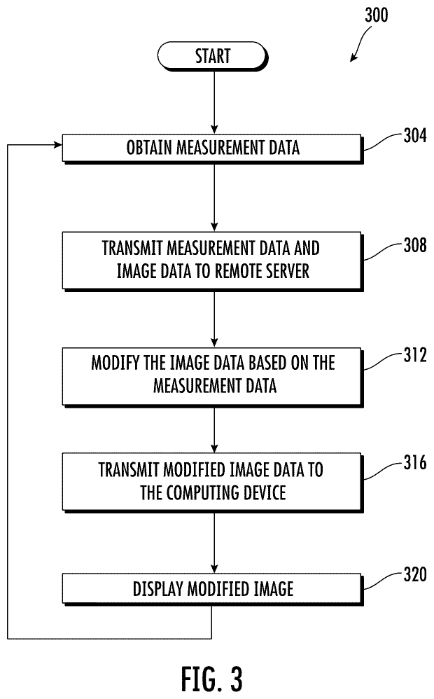

With reference to FIG. 3, a flowchart depicts a first exemplary method 300 of operating the medical monitoring system 100. The method 300, in one embodiment, is provided as stored program instructions for a software application. For example, the software application is stored in the memory 160 the computing device 108 and/or the memory 204 of the remote server 112. Upon execution by at least one of the corresponding processors 128, 176 the software application is configured to perform the method 300 shown in FIG. 3. The software application is also referred to as an “app.”

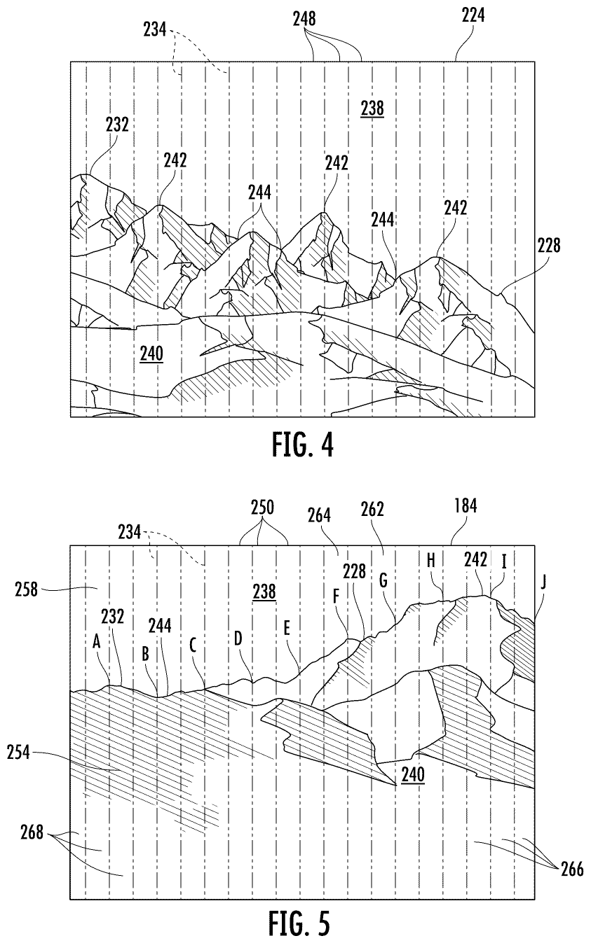

In the method 300 and with additional reference to FIG. 4, the medical monitoring system 100 operates an app (stored as the app data 180) on the computing device 108 that starts with a nonmedical image 224 saved as the image data 198 and then changes or modifies the nonmedical image 224 so that a feature 228 of the nonmedical image 224 represents the measurement data 158 generated by the measurement device 104. Each aspect of the first method 300 is described below.

At block 304 of the method 300, the measurement data 158 is generated by the measurement device 104 and is obtained from the measurement device 104 by the computing device 108. As shown in FIG. 2, exemplary measurement data 158 includes a plurality of measurement values and corresponding time values at which the measurement values were recorded. Initially, the measurement data 158 is stored in the memory device 120 of the measurement device 104. However, in response to a request from the computing device 108, for example, the measurement device 104 transmits the measurement data 158 either directly to the computing device 108 or indirectly to the computing device 108 via the Internet 148 using the transceivers 124, 164. The computing device 108 stores the obtained measurement data 158 in the memory device 160.

In an embodiment, the time and measurement values of the measurement data 158 are translated, converted, and/or calibrated into suitable, appropriate, or desired units on at least one of the measurement device 104, the computing device 108, and the remote server 112. The measurement data 158 may be translated, converted, and/or calibrated based on the country or location of usage and the health function being measured, among other factors. The original, unconverted, or uncalibrated measurement data 158, in some embodiments, remains stored in the memory 120 of the measurement device 104 as an indicator of time and/or the raw current units.

The measurement device 104 periodically generates the measurement data 158 according to a predetermined time period, such as every five minutes, in an example. The measurement data 158 shown in FIG. 2 is simplified and includes measurement values and time values spaced thirty minutes apart (another predetermined time period). The computing device 108, in one embodiment, periodically obtains the measurement data 158 from the measurement device 104 each time a new measurement value is saved to the memory device 120. Alternatively, the computing device 108 waits for a predetermined time period to elapse or until a predetermined number of the measurement and time values are saved to the memory device 120 prior to obtaining the measurement data 158.

Next at block 308, the method 300 includes transmitting the measurement data 104 and the image data 198 to the remote server 112 for processing by the processor 208, such that the remote server 112 obtains the measurement data 104 and the image data 198. In this example, the remote server 112 performs the modification of the nonmedical image 224. In other embodiments, the remote server 112 is not required and the modification of the nonmedical image 224 is performed by the processor 176 of the computing device 108. Moreover, in other embodiments, the measurement data 158 is transmitted to the remote server 112 via the Internet without first being transmitted to the computing device 108.

As shown in FIG. 4, an exemplary nonmedical image 224 depicts a landscape having a mountain range. The dashed vertical lines 234 overlaid on the nonmedical image 224 are not part of the image 224, but are included to assist in describing the image modification process according to the method 300. As used herein, the nonmedical image 224 is an image not involving, relating to, used in, or concerned with medical care or the field of medicine. The nonmedical image 224 is not a chart or graph of medical data or measurement data 158. As used herein, a medical image is an image relating to, used in, or concerned with medical care or the field of medicine. A graph or chart of the measurement data 158 is a medical image.

The exemplary nonmedical image 224 of FIG. 4 shows a horizon 232 between the sky 238 and the Earth 240. The horizon 232 is the feature 228 of the nonmedical image 224 that is that is changed, modified, adjusted, re-drawn, and/or otherwise manipulated to represent the measurement data 158. The horizon 232 is a line where the sky 238 meets the Earth 240, and in which the “Earth” is ground or water. A sky-side image portion of the nonmedical image 224 is located above the horizon 232 opposite the Earth, and may include clouds and/or any other element typically located in the sky. An Earth-side image portion of the nonmedical image 224 is located opposite the sky 238 and the sky-side portion and includes the Earth. The exemplary horizon 232 includes several peaks 242 of the mountain range and several valleys 244 of the mountain range. In FIG. 4, the nonmedical image 224 does not represent the measurement data 158. Instead, for example, the nonmedical image 224 a digital representation of a photograph of an actual mountain range or an artist's depiction of a mountain range that was created without connection to the measurement data 158. Other suitable subject matter for the nonmedical image 224 includes, but is not limited to, sand dunes, water waves, and city skylines. Most nonmedical images 224 depicting a horizon 232 are suitable nonmedical images 224 for use with the medical monitoring system 100. Additionally, abstract art or any other nonmedical image having a prominent stripe, line, ridge, or groove (each of which is a feature 228) is a suitable nonmedical image 224 for use with the medical monitoring system 100.

At block 312 of the method, the processor 208 of the remote server 112 modifies the image data 198 of the nonmedical image 224 based on the measurement data 158 to generate the modified image data 212 that corresponds to the modified image 184. The modified image data 212 is initially saved in the memory device 204 of the remote server 112. As used herein, modifying the image data 198 includes changing the image data 198 to change the appearance of the nonmedical image 224 as rendered on the display screen 172. The changes to the nonmedical image 224 result in the modified image 184 having the feature 228 that represents the measurement data 158. In some embodiments, the method 300 includes extending or appending an image portion to a previously-generated nonmedical image 224 so that the method 300 maintains consistent imagery that allows for smooth animation.

An exemplary modified image 184 is shown in FIG. 5. In the modified image 184, the processor 208 has modified the image data 198 so that the feature 228 has been changed to represent the measurement data 158. Specifically, as an example of changing the feature 228, the processor 208 changes the appearance of the horizon 232 so that the peaks 242, valleys 244, and contour of the mountain range correspond to the measurement values of the measurement data 158 in chronological order based on the time values of the measurement data 158. As such, changing the feature 228 includes increasing the height of a valley 244 or a peak 242, decreasing the height of a valley 244 or a peak 242, and flattening or removing a valley 244 or a peak 242, so that the horizon 232 represents the measurement values of the measurement data 158. In this example, the horizontal direction of the modified image 184 corresponds to time, with older measurement values shown on the left side of the image 184 and with newer measurement values shown on the right side of the image 184. The vertical direction of the modified image 184 corresponds to the magnitude of the measurement values with comparatively higher magnitudes shown with the feature 228 closer to the top of the image 184 (less sky 238, smaller sky-side image portion, more Earth 240) and with comparatively lower magnitudes shown with the feature 228 closer to the bottom of the image 184 (more sky 238, larger sky-side image portion, less Earth 240).

In one embodiment, the modified image 184 as shown on the display screen 172 does not include a scale in which the user can determine the magnitude of the measurement values of the measurement data 158. This is because the modified image 184 is a nonmedical image that is not a chart or graph of medical data. Instead, the feature 228 of the modified image 184 conveys trends or changes in the measurement data 158 to the user, instead of directly displaying the measurement values of the measurement data 158. For example, as shown in FIG. 5, the feature 228 is generally flat from measurement point A to measurement point C, which is consistent with the corresponding measurement values that are trending flat. The user can therefore determine that their blood glucose was relatively stable during this time period. From measurement points C to I, the feature 228 shows an incline, which is consistent with measurement values of the measurement data 158 that are trending upward. The user can therefore determine that their blood glucose is increasing during this time period. From measurement points I to J, feature 228 shows a decline, which is consistent with measurement values of the measurement data 158 that are trending downward. The user can therefore determine that their blood glucose is decreasing during this time period. The modified image 184 provides insights into the user's measurement data 158 requiring just a glance from the user and without displaying any of the measurement values or time values.

According to one approach for changing the feature 228, the processor 208 segments the nonmedical image 224 into a plurality of segments 248 (FIG. 4), as identified by the dashed lines 234. Each segment 248 includes a portion of the feature 228 that is to be modified to represent the measurement data 158. Then, as shown in FIG. 5, the processor 208 generates modified segments 250 in which the portion of the feature 228 in that segment 250 has been moved or changed to correspond to at least one of the measurement values of the measurement data 158.

For example, the modified image 184 of FIG. 5 includes a feature 228 that has been changed based on the measurement data 158 having the labels A-J in FIG. 2, and there are additional measurement values and time values between the labeled measurement data 158. As shown by the time values, the “A” data 158 is a prior measurement value that was generated before the “B” data 158, which is a subsequent measurement value that was generated after the “A” data 158. In this example, the subsequent measurement value (“B” data, 80 mg/dl) is less than the prior measurement value (“A” data, 85 mg/dl). As a result, the processor 208 has modified the image data 198 of the “B” data modified segment 254 to change the feature 228 to increase the showing of the sky 238 (i.e., increase the showing of the image portion on the sky-side of the horizon 232 and decrease the showing of the image portion on the Earth-side image portion) so that the horizon 232 is lower at the “B” data modified segment 254 as compared to the showing of the horizon 232 at the “A” data modified segment 258. This can also be thought of as modifying the image data 198 to lower the horizon 232 in this example.

In another example, the “F” data 158 is a prior measurement value that was generated before the “G” data 158, which is a subsequent measurement value. In this example, the subsequent measurement value (“G” data 130 mg/dl) is greater than the prior measurement value (“F” data 125 mg/dl). As a result, the processor 208 has modified the image data 198 of the “G” data modified segment 262 to change the feature 228 to decrease the showing of the sky 238 (i.e., decrease the showing of the image portion on the sky-side of the horizon 232 and increase the showing of the image portion on the Earth-side image portion) so that the horizon 232 is higher at the “G” data modified segment 262 as compared to the showing of the horizon 232 at the “F” data modified segment 264. This can also be thought of as modifying the image data 198 to raise the horizon 232 in this example. The processor 208 performs this analysis for each measurement value of the measurement data 158 to generate the modified image data 212 of the modified image 184. The modified segments 250 are arranged chronologically based on the corresponding time values of the measurement data 158.

As a consequence of changing the feature 228 in the manner described above, the peaks 242 and valleys 244 of the mountain range are resized and/or repositioned to represent the measurement values of the measurement data 158. As such, the mountain range can be shown in markedly different configurations depending on the measurement data 158. For example, if the measurement data 158 includes mostly the same measurement values, then the feature 228 will be changed to have a generally flat horizon 232 with little to no differentiation between the peaks 242 and the valleys 244. If the measurement values of the measurement data 158 are increasing or decreasing at a generally constant rate then the feature 228 will be changed to an inclined plane, again with little to no differentiation between the peaks 242 and the valleys 244. When, however, the measurement data 158 includes measurement values that increase and decrease over time, then the peaks 242 and valleys 244 of the horizon 232 are repositioned and/or resized, such that the mountain range appears to be whole new mountain range.

Next, at block 316 the method 300 includes transmitting the modified image data 212 to the computing device 108 using the transceivers 164, 200 via the Internet 148. This process is also referred to as downloading the modified image data 212 with the computing device 108. The computing device 108 is configured to store the modified image data 212 in the memory device 160.

At block 320 of the method 300, the computing device 108 displays the modified image 184 on the display screen 172. Displaying the modified image 184 includes rendering the modified image data 212 as the modified image 184 on the display screen 172 using the processor 176.

As shown in the flowchart of FIG. 3, the method 300 returns to block 304 after displaying the modified image 184 so that the computing device 108 may obtain additional measurement data 158 from the measurement device 104 that was not previously encoded into the modified image 184. In one embodiment, after receiving the additional measurement data 158, the computing device 108 transmits the additional measurement data 158 to the remote server 112 for processing by the processor 208. The processor 208 selects a predetermined number of the segments 248 and then changes the feature 228 shown in the segments 248 to generate updated modified segments 266 that are stored in the memory device 204 as updated modified image data 212. The updated modified segments 266 each include a feature 228 that corresponds to a measurement value of the additional measurement data 158. In generating the updated modified segments 266, the processor 208 also blends the updated modified segments 266 into the modified image 184 that was previously generated so that the feature 228 flows smoothly through all of the updated modified segments 266 in a continuous, seamless, and/or congruous manner.

For example, with reference to FIG. 5, the display screen 172 of a certain computing device 108 is configured to display only the portion of the modified image 184 associated with the measurement data 158 “A” through “H”. The additional measurement data 158 corresponds to the measurement data 158 “I” and “J”. The processor 208 generates the updated modified segments 266 and appends the updated modified segments 266 to the modified image 184. The updated modified segments 266 are appended to the right side of the modified image 184, because the updated modified segments 266 correspond to the most recent measurement data 158. Additionally, the modified image data 212 of the oldest segments 268 are not shown as part of the modified image 184. In this way, the modified image 184 is a dynamic wallpaper or home screen that is scrolled from right to left to display a representation of the most recent measurement data 158 generated by the measurement device 104 for a predetermined time period. An exemplary predetermined time period is from thirty minutes to twenty-four hours. In at least one embodiment, the image smoothly advances horizontally in time in real-time (i.e., real-time computing), in a pixel-by-pixel, or minutely fashion to render a seamless animation of the feature 228.

In one embodiment, the image data 198 includes data corresponding to a plurality of nonmedical images 224. For example, the computing device 108 renders one or more of the nonmedical images 224 on the display screen 172 and the user interacts with the input device 168 to generate input data 192 identifying a selected nonmedical image 224 to be modified based on the measurement data 158. The user may select the nonmedical image 224 by touching the touchscreen 168, by pressing the button 168, and/or by speaking into the microphone 168. In some embodiments, the nonmedical images 224 are internally tested, recommended, and sourced to maintain alignment with company/product branding, to ensure general aesthetics, and/or psychological motivation.

In another embodiment, each nonmedical image 224 of the plurality of nonmedical images 224 is assigned a corresponding theme of a plurality of themes. The themes are saved in the memory device 160 of the computing unit 108 as theme data 204. The computing device 108 is configured to receive input data 192 from the user corresponding to a selected theme of the plurality of themes. The selected theme is also saved to the memory device 160 as the theme data 204. Then, the one or more nonmedical images 224 having an assigned theme that matches the selected theme are shown on the display screen 172. The user is able to narrow her choices of the nonmedical images 224 and then selects a nonmedical image 224 corresponding to or matching the selected theme. Example themes include snowy mountains, grassy mountains, rolling hills in the summer, rolling hills in the fall, sand dunes, water waves, nighttime city skylines, and daytime city skylines.

In a further embodiment, the nonmedical image 224 is selected based on a best fit curve approach. According to this approach, for each nonmedical image 224 of the image data 198, the processor 176 determines a feature mathematical function that corresponds to a feature curve defined by the feature 228. Then, the processor 176 analyzes the measurement values of the measurement data 158 to determine a data mathematical function that corresponds to a data curve defined by the measurement values. Next, values of the data mathematical function are compared to values of the image mathematical functions to identify the feature curve that is a best fit to the data curve. The nonmedical image 224 corresponding to the best fit feature curve is selected as the selected nonmedical image 224. This approach typically results in the selected nonmedical image 224 requiring fewer changes to the feature 228 in order to modify the image data 184 to represent the measurement data 158, thereby saving processing power.

In some embodiments, the nonmedical images 224 are ranked according to their usage by collecting corresponding data from the computing device 108. In selecting the nonmedical image 224, the user may be presented with the most highly-ranked nonmedical images 224 first. Additionally or alternatively, in selecting the nonmedical image 244, the images 224 may be filtered based on the user's age, gender, type of diabetes, therapy type, and interests, to assist the user in determining the selected nonmedical image 224.

As shown in FIG. 1, in some embodiments at block 320 of the method 300, the processor 176 of the computing device 108 obtains the overlay data 206 and renders graphics 272 corresponding to the overlay data 206 on the modified image 184, as shown on the display screen 172. Exemplary overlay data 206 include the time of day, weather information, and the status of the computing device 108 including signal strength and battery state of charge. The overlay data 206 is rendered as time of day graphics, weather information graphics, and/or status graphics, as shown in FIG. 1. The overlay data 206 can be obtained by downloading the overlay data 206 from the Internet 148, for example.

With continued reference to FIG. 1, the overlay data 206 has also resulted in the display of a critical state graphic 274 that corresponds to critical state information. For example, in some embodiments, the processor 176 of the computing device 108 compares the measurement values of the measurement data 158 to a predefined range of condition values to determine if the measurement data 158 is indicative of a potential health issue for the user (i.e., an exemplary critical state). For example, embodiments of the medical monitoring system 100 configured to monitor glucose concentrations may compare the measured glucose concentrations of the measurement data 158 to a predefined range of condition values including a predetermined minimum safe glucose concentration value and a predetermined maximum safe glucose concentration value. When at least one of the measured values of the measurement data 158 is less than the predefined minimum value or is greater than the predetermined maximum value (i.e., outside of the predefined range), then the processor 176 is configured to render the predetermined critical state graphic 274 on the display screen 172 to provide notice to the user of the potential health issue.

The predetermined critical state graphic 274 is configurable and/or selectable by the user, so that the user understands the meaning of the graphic 274 and understands why the graphic is being shown 274. In one example, the predetermined critical state graphic 274 is a color frame overlay (not shown) that is displayed around the periphery of the nonmedical image 224 and/or the periphery of the display screen 172. The color of the color frame overlay indicates a severity, a seriousness, and/or an urgency of the measured health function. For example, when the measured health function is below a predetermined value, then the color frame overlay is a first color, such as yellow. When the measured health function is greater than or equal to the predetermined value, then the color frame overlay is a second color that is different from the first color, such as red. In another example represented in FIG. 1, the critical state graphic 274 is a dog icon and is a nonmedical graphic to maintain the privacy of the user in situations in which others can view the display screen 172. As such, even in the event of a potential health issue or other critical state, as identified by the computing device 108, the entire GUI 188 is nonmedical and an uninformed observer would have no indication that the user is interpreting the modified image 184 to gain insights into the state of a measured health function. The critical state graphic 274 is included in FIG. 1 for descriptive purposes only, and the measured values of the measurement data 158 shown in FIG. 2 do not result in the computing device 108 determining the potential health issue or another critical state for most people.

Additionally, upon seeing the critical state graphic 274, upon reaching a point of privacy, or at any other time the user can easily navigate to or open a corresponding app stored as the app data 180 and view directly the measurement values and the time values of the measurement data 158 so that an appropriate health decision can be made. Accordingly, the processor 176 is configured to render the measurement data 158 on the display screen 172 in addition to or in alternative to the modified image 184. The method 300 does not prevent the user from accessing directly the measurement data 158, instead, the method 300 is a nonmedical means of conveying trends in the measurement data 158 to the user. Exemplary health decisions include eating a meal or snack, delaying a meal or snack, administering insulin, delaying the administration of insulin, beginning an exercise routine, ending an exercise routine, and contacting emergency services.

In some embodiments, the overlay data 206 may also include a highlight graphic (not shown) that is overlaid on the modified image 184 in order to emphasize and/or highlight the feature 228. The highlight graphic tends to decrease confusion and misinterpretation of the user when interpreting the modified image 184. In one embodiment, the highlight graphic follows the feature 228 and is shown in a color that is easily distinguished from the scene or subject matter of the modified image 184. For example, the highlight graphic could be configured to follow the horizon 232 in the exemplary modified 184 image of the mountain range.

As shown in FIG. 2, the measurement data 158 are measured values as determined by the sensor 116. In some embodiments, the measured data 158 further includes predicted measurement values corresponding to future time values. The predicted measurement values are not generated by the sensor 116. Instead, the predicted measurement values of the measurement data 158 are generated by at least one of the processors 128, 176, 208 using an algorithm. The algorithm, in one embodiment, determines the predicted measurement values based on the sensor-generated measurement data 158, known characteristics of the user, and factors specific to the health function being monitored. In one embodiment, the predicted measurement values are included in the modified image 184, but are visually distinguished from the measurement data 158 generated by the sensor 116. That is, the predicted measurement values are represented by the feature 228 in the modified image 184, but are illustrated differently from the portion of the feature 228 that is based on the sensor-generated measurement values. For example, the portion of the modified image 184 and the feature 228 based on the predicated measurement values is shown on the display screen 172 in a muted or dulled color scheme, as compared to the portion of the modified image 184 and the feature 228 generated based on the sensor-generated measurement values. Additionally or alternatively, a dividing line or boundary line (not shown) may be displayed between the two portions of the modified image 184 to further visually distinguish the portion of the modified image 184 based on the predicted measurement values from the portion of the modified image 184 based on the sensor-generated measurement values.

In the above-described example, the method 300 of FIG. 3 was described with the remote server 112 (i) receiving the measurement data 158 and the image data 198, and (ii) performing the processing of the image data 198 to generate the modified image data 212 corresponding to the modified image 184. In another embodiment of the method 300, the computing device 108 is configured to generate the modified image data 212 without usage of the remote server 112. In particular, the processor 176 of the computing device 108 is configured to perform the method 300 and to generate the modified image data 212 without sending any data to the remote server 112.

Moreover, in other embodiments, the machine learning model 216 is used to generate the modified image 184 instead of the segmented approach feature 228 modification approach described above. In such an embodiment, the image data 198 of the nonmedical image 224, the measurement data 158, and the prompt data 210 are transmitted to the remote server 112. The prompt data 210 corresponds to a prompt that instructs the machine learning model 216 to change the feature 228 of the nonmedical image 224 to represent the measurement values of the measurement data 158. The machine learning model 216 then outputs the modified image data 212 corresponding to the modified image 184 in which the feature 228 represents the measurement data 158. In a further embodiment, the machine learning model operates 216 and is stored on the memory device 160 of the computing device 108 instead of the remote server 112.

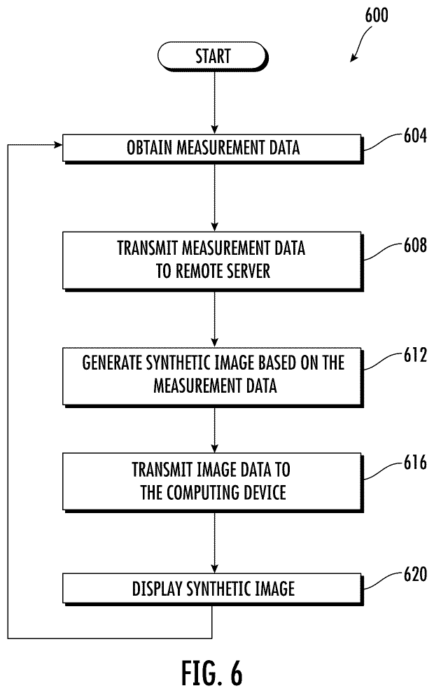

As shown in FIG. 6, a flowchart depicts a second exemplary method 600 of operating the medical monitoring system 100. The method 600, in one embodiment, is provided as stored program instructions for a software application. For example, the software application is stored in the memory 160 the computing device 108 and/or the memory 204 of the remote server 112. Upon execution by at least one of the corresponding processors 128, 176 the software application is configured to perform the method 600 shown in FIG. 6. The software application is also referred to as an “app.”

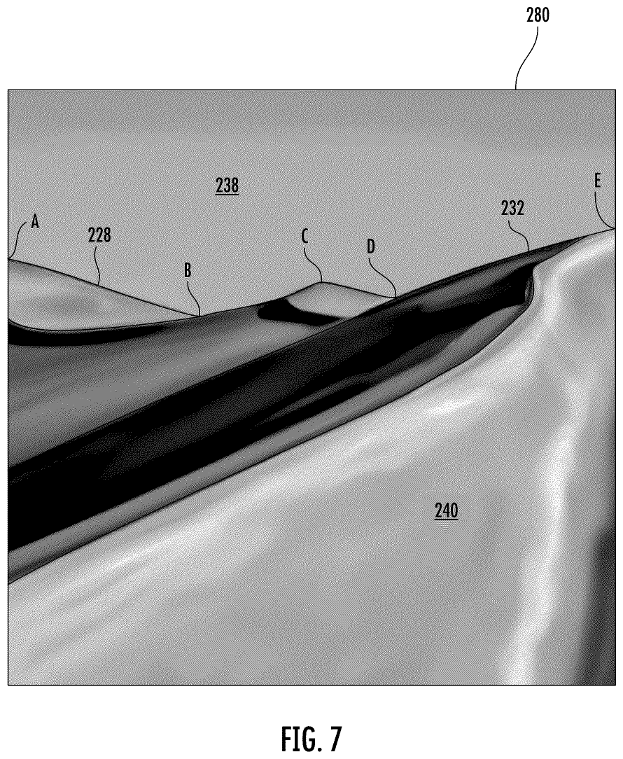

The method 600 does not start with the nonmedical image 224, as is described in the method 300. Instead, the method 600 generates a synthetic nonmedical image 280 (FIG. 7) using the machine learning model 216. The synthetic nonmedical image 280 includes the feature 228 that represents the measurement data 158 and that shows at least one trend in the measurement data 158. Each aspect of the second method 600 is described below.

At block 604, the method 600 includes obtaining and/or receiving the measurement data 158 generated by the measurement device 104. The measurement data 158 is initially stored in the memory device 120 of the measurement device 104. However, in response to a request from the computing device 108, for example, the measurement device 104 transmits the measurement data 158 either directly to the computing device 108 or indirectly to the computing device 108 via the Internet 148 using the transceivers 124, 164. The computing device 108 stores the obtained measurement data 158 in the memory device 160.

Next at block 608, the measurement data 158 and prompt data 210 are transmitted to the remote server 112, and the remote server 112 obtains and/or receives the measurement data 158 and the prompt data 210. Typically, the measurement data 158 and the prompt data 210 are transmitted via the Internet 148 to the remote server 112. The measurement data 158 includes the measurement values and the corresponding time values, but, in this example, not the same values as shown in FIG. 2. No image data, such as the image data 198, is transmitted to the remote server 112.

The prompt data 210 includes a prompt (i.e., text-based instructions or guidance) that is provided to the machine learning model 216 for causing the machine leaning model 216 to generate the synthetic nonmedical image 280. Exemplary prompts are “sand dunes,” “mountain range,” and “waves on the beach.” Accordingly, the prompt is the subject matter or theme of the synthetic nonmedical image 280, and the measurement data 158 is used by the machine learning model 216 to shape the feature 228 of the synthetic nonmedical image 280.

At block 612 of the method 600 and with reference to FIG. 7, the machine learning model 216 generates the synthetic image data 214 that corresponds to the synthetic nonmedical image 280. The synthetic nonmedical image 280 is a unique computer-generated image that is generated based on learned correlations with text captions to a library of images. The synthetic nonmedical image 280 includes the feature 228 that represents the measurement data 158. The synthetic image data 214 is stored, initially, in the memory device 204 of the remote server 112.

As shown in FIG. 7, the exemplary synthetic nonmedical image 280 was generated with the “sand dunes” prompt and includes a horizon 232 as the feature 228 that corresponds to the measurement data 158. The feature 228 does not correspond to the exemplary measurement data 158 of FIG. 2, but instead corresponds to different measurement data 158. The synthetic nonmedical image 280 is not a preexisting image that has been segmented, adjusted, or otherwise changed by the processor 208. Instead, the synthetic nonmedical image 280 is a new image corresponding to the subject matter of the prompt and having the feature 228 that represents the measurement data 158.

The feature 228 of the synthetic nonmedical image 280 shows trends in the measurement data 158. For example, from the point A to the point B, the feature 228 shows a downward trend in which the blood glucose concentration decreases. Another decreasing trend is shown from the point C to the point D. From the point B to the C, the feature 228 shows an upward trend in which the blood glucose concentration increases. Another increasing trend is shown from the point D to the point E.

At block 616 of the method 600, the synthetic image data 214 is transmitted from the remote server 112 to the computing device 108 and is stored in the memory device 160. The transceivers 164, 200 and the Internet 148 are used to transmit the synthetic image data 214. This process is also referred to as downloading the synthetic image data 214 with the computing device 108.

Next, at block 620, the processor 176 of the computing device 108 renders the synthetic image data 214 as the synthetic nonmedical image 280 on the display screen 172. Corresponding overlay data 206 may be rendered and displayed as the overlay graphics described in connection with FIG. 1.

For example, the processor 176 may render the critical state graphic 274 overlaid on the synthetic nonmedical image 280. To determine when the critical state graphic 274 should be rendered, the processor 176 of the computing device 108 compares the measurement values of the measurement data 158 to a predefined range of condition values to determine if the measurement data 158 is indicative of a potential health issue for the user. For example, embodiments of the medical monitoring system 100 configured to monitor glucose concentrations may compare the measured glucose concentrations of the measurement data 158 to a predefined range of values including a predetermined minimum safe glucose concentration value and a predetermined maximum safe glucose concentration value. When at least one of the measured values of the measurement data 158 is outside of the predefined range, then the processor 176 is configured to render the predetermined critical state graphic 274 over the synthetic nonmedical image 214 on the display screen 172 to provide notice to the user of the potential health issue. The predetermined critical state graphic 274 is configurable and/or selectable by the user, so that the user understands the meaning of the graphic 274 and understands why the graphic is being shown 274.

As shown in the flowchart of FIG. 6, the method 600 returns to block 604 after displaying the synthetic nonmedical image 280 so that the computing device 108 may obtain and/or receive additional measurement data 158 from the measurement device 104 that was not previously provided to the machine learning model 216. In one embodiment, after receiving the additional measurement data 158, the computing device 108 transmits the additional measurement data 158 to the remote server 112 for processing by the processor 208 and the machine learning model 216. The additional measurement data 156 is used to generate updated synthetic image data 214 of an updated synthetic nonmedical image portion (not shown) that is appended to or otherwise combined with the already displayed synthetic nonmedical image 280. The updated synthetic nonmedical image portion includes an updated feature 228 that is representative of the additional measurement data 158. In generating the updated synthetic nonmedical image portion, the processor 208 configures the machine learning model 216 to blend and/or to combine updated synthetic nonmedical image portion into the synthetic nonmedical image 280 that was previously generated so that the feature 228 flows continuously, seamlessly, and/or congruously through the image 280 and the updated synthetic nonmedical image portion.

In one embodiment, the method 600 includes extending and/or identifying a portion of the horizon 232 of the synthetic image 280 that corresponds to the measurement data 158. For example, at block 612 of the method 600, the machine learning model 216 generates the synthetic nonmedical image data 214 based on the prompt data 210, but not necessarily corresponding to the measurement data 158. This is because, in at least some embodiments, the machine learning model 216 may not generate a suitable version of the synthetic image 280 that corresponds well enough to the measurement data 158 on the first image generation request. The synthetic image associated with the synthetic nonmedical image data 214 is a theme image and illustrates sand dunes or a mountain, for example. The horizon 232 of the theme image does not correspond to the measurement values of the measurement data 158 or does not corresponds well enough to the measurement values of the measurement data 158.

Next, the method 600 includes iterating the synthetic nonmedical image data 214 and/or the prompt data 210 through the machine learning model 216 until at least a portion of the horizon 232 of the theme image corresponds to the measurement data 158 or corresponds well enough to the measurement data 158. In one example, the machine learning model 216 repeatedly generates the synthetic image data 214 based on the prompt data 210 to generate multiple versions of the theme image. The synthetic image data 214 of each theme image is processed by the processor 208 to determine if any portion of the horizon 232 of the theme image corresponds to the measurement data 158. If there is no portion of the horizon 232 corresponding to the measurement data 158, then the theme image is discarded or is iterated again through the machine learning model 216. When, however, the processor 208 determines that the theme image includes at least a portion of the horizon 232 that corresponds to the measurement values of the measurement data 158, then the iteration stops. The iterations are useful, for example, to avoid unnatural or unrealistic “steps” in the horizon 232 of the synthetic image 280 based on the measurement values of the measurement data 158.

In response to identifying the portion of the horizon 232 that corresponds to the measurement data 158, that portion of the synthetic image data 214 of the theme image is extracted as the synthetic image data 214 and is rendered on the display screen 172. For example, the machine learning model 214 may generate a theme image including a left portion and a right portion. Only the right portion of the theme image includes the feature 228 corresponding to the measurement data 158. As such, the processor 208 discards the synthetic image data 214 of the left portion of the theme image and retains the synthetic image data 214 of the right portion of the theme image as the synthetic image 280 that is shown/rendered on the display screen 172 in representation of the measurement data 154.

The above-described iterative process is repeated based on the next measurement value of the measurement data 158 generated by the measurement device 104. That is, as additional measurement data 158 is generated, the machine learning model 216 is used to iteratively generate image portions that “extend” the horizon 232 of the synthetic image 280 in a smooth and natural way. The new iteratively-generated image portion is then appended to the previously-generated synthetic image 280 in order to show a representation of the next measurement value to the user on the display screen 172. The iterative process assists in avoiding unnatural or unrealistic “steps” in the horizon 232 of the combined synthetic image 280.

As described above, the measurement device 104 is a CGM; however, in other embodiments, the measurement device 104 is provided as a spot glucose measuring device that generates the measurement data 158 in response to analyzing the user's blood as deposited on a disposable test strip (not shown) instead of monitoring the interstitial fluid 144. The methods 300, 600 operate the same with a CGM and a spot glucose measuring device, which is also referred to as a glucose meter or a glucometer.

Moreover, the methods 300, 600 can be applied to other types of measurement data 158 including blood pressure data, cholesterol level data, coagulation data, heart rate, basal temperature, and other types of health functions. In these other embodiments, the measurement device 104 includes one or more of a blood pressure sensor for generating blood pressure measurement data, a cholesterol level sensor for generating cholesterol level measurement data, a blood coagulation sensor for generating coagulation measurement data, a heart rate sensor for generating heart rate data (i.e., pulse data), and a thermometer for generating basal temperature data. After generation of the measurement data 158 from any one or more of the sensors, the methods 300, 600 proceed in the same way to generate the modified image 184 and/or the synthetic image 280 associated with the corresponding measured health function.

The medical monitoring system 100 and the methods 300, 600 are an improvement to the technology of medical monitoring, medical condition management, and user privacy. As described above, certain conditions, such as diabetes, require the person to regularly and periodically monitor their blood glucose concentration levels. As a result, at some point, most people will find themselves in a public setting with the need to monitor their blood glucose concentration levels. CGMs prevent these people from having to prick their finger; however, displaying the measurement data 158 in a medical image on a smartphone may result in the disclosure of private medical information that the user does not want to share. The medical monitoring system 100 and the methods 300, 600 enable the user to monitor trends in their blood glucose concentration levels and even determine when a potential health issue may occur all without disclosing private medical data in any obvious way. This is because, the measurement values of the measurement data 158 are “hidden” or encoded into the nonmedical modified image 184 and the synthetic nonmedical image 280. An uninitiated person, even when looking directly at the images 184, 280, would not suspect that the person is managing a medical condition. As a result, when in public setting, the person does not have to excuse themselves or hide their display screen 172 when checking their blood glucose concentration levels. The generation, rendering, and display of the images 184, 280 is an improvement to the technology of medical monitoring, medical condition management, and user privacy.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method of operating a medical monitoring system, comprising:
providing stored program instructions for a software application, the software application being configured to be stored in a non-transitory memory of a computing device and, upon execution by a processor of the computing device, the software application being configured to:
obtain measurement data;
store image data of a nonmedical image on the non-transitory memory;
modify the image data based on the measurement data to generate modified image data; and
render the modified image data as a modified image on a display screen of the computing device,
wherein modifying the image data includes changing a feature of the nonmedical image to represent the measurement data.

2. The method as claimed in claim 1, wherein:
the feature is a horizon,
the measurement data includes measurement values and corresponding time values, and
changing the feature includes changing the horizon to represent the measurement values in chronological order according to the time values.

3. The method as claimed in claim 2, wherein:
the measurement values include a prior measurement value and a subsequent measurement value, and
changing the feature further comprises:
changing the horizon to decrease a showing of an image portion located on a sky-side of the horizon in response the subsequent measurement value being greater than the prior measurement value, and
changing the horizon to increase the showing of the image portion located on the sky-side of the horizon in response to the subsequent measurement value being less than the prior measurement value.

4. The method as claimed in claim 2, wherein:
the nonmedical image depicts a mountain range,
the horizon includes at least one peak of the mountain range and/or at least one valley of the mountain range, and
changing the feature of the nonmedical image further comprises resizing and/or repositioning the at least one peak and/or the at least one valley to represent the measurement values.

5. The method as claimed in claim 1, wherein the nonmedical image is a selected nonmedical image of a plurality of nonmedical images, the software application being further configured to:
store image data of the plurality of nonmedical images in the non-transitory memory, each nonmedical image having a corresponding feature;
determine a feature mathematical function for each feature of the nonmedical images of the plurality of nonmedical images, the feature mathematical function defining a feature curve defined by the corresponding feature;
determine a data mathematical function corresponding to a data curve defined by measurement values of the measurement data; and
compare values of the data mathematical function to values of the image mathematical function to identify the selected nonmedical image as the nonmedical image of the plurality of nonmedical images having a feature curve that is a best fit to the data curve.

6. The method as claimed in claim 1, wherein the nonmedical image is a selected nonmedical image of a plurality of nonmedical images, the software application being further configured to:
receive input data from a user from an input device of the computing device, the input data identifying the selected nonmedical image.

7. The method as claimed in claim 1, the software application being further configured to:
receive input data from a user from an input device of the computing device, the input data corresponding to a selected theme of a plurality of themes stored as theme data in the non-transitory memory,
wherein the nonmedical image is a selected nonmedical image of a plurality of nonmedical images,
wherein each nonmedical image is assigned a theme of the plurality of themes, and
wherein the theme of the selected nonmedical image matches the selected image theme.

8. The method as claimed in claim 1, the software application being further configured to:
obtain overlay data corresponding to a time of day, weather information, and/or critical state information; and
render the overlay data as time of day graphics, weather information graphics, and/or critical state graphics overlaid on the modified image as shown on the display screen.

9. The method as claimed in claim 1, the software application being further configured to:
generate the modified image data with a machine learning model operating on (i) a processor of a remote server in communication with the computing device, and/or (ii) the processor of the computing device.

10. The method as claimed in claim 1, wherein:
the measurement data includes measurement values and corresponding time values,
modifying the image data further comprises:
segmenting the nonmedical image into a plurality of segments, each segment including a portion of the feature;
generating a plurality modified segments by changing the portion of the feature of each segment to represent at least one measurement value; and
chronologically arranging the modified segments based on the corresponding time values to form the modified image.

11. The method as claimed in claim 10, the software application being further configured to:
obtain additional measurement data;
generate an updated modified segment having a portion of the feature that corresponds to a measurement value of the additional measurement data;
append the updated modified segment to the modified image; and
delete image data corresponding to an oldest modified segment from the modified image.

12. The method as claimed in claim 1, the software application being further configured to:
render the measurement data on the display screen.

13. A medical monitoring system, comprising:
a measurement device including a sensor configured to generate measurement data;
a remote server configured (i) to receive the measurement data, (ii) to store image data of a nonmedical image on a non-transitory memory, and (iii) to modify the image data based on the measurement data to generate modified image data using a processor of the remote server; and
a computing device in communication with the remote server and configured to receive the modified image data, the computing device including a processor configured to render the modified image data as a modified image on a display screen of the computing device,
wherein modifying the image data includes changing a feature of the nonmedical image to represent the measurement data.

14. The medical monitoring system of claim 13, wherein:
the measurement device is a body-worn continuous glucose monitor,
the sensor is configured to detect glucose in interstitial fluid, and
the measurement data is representative of a blood glucose concentration over time.

15. The medical monitoring system of claim 13, wherein the computing device is one of a smartphone, a smartwatch, a laptop computer, and a desktop computer.

16. A method of operating a medical monitoring system, comprising:
receiving measurement data with a remote server;
generating synthetic image data of a synthetic nonmedical image based on the measurement data with the remote server, the synthetic nonmedical image including a feature that is representative of the measurement data; and
transmitting the synthetic image data to a computing device for rendering as the synthetic nonmedical image on a display screen of the computing device,
wherein the synthetic nonmedical image is generated by a machine learning model operated on the remote server, and
wherein at least one trend in the measurement data is shown by the feature of the synthetic nonmedical image.

17. The method as claimed in claim 16, wherein the feature is a horizon that is representative of the measurement data.

18. The method as claimed in claim 16, further comprising:
receiving additional measurement data with the remote server;
generating updated synthetic image data of an updated synthetic nonmedical image portion having an updated feature that is representative of the additional measurement data; and
processing the updated synthetic image data and the synthetic image data with a processor of the remote server or the computing device, such that the updated synthetic nonmedical image portion is appended to the synthetic nonmedical image.

19. The method as claimed in claim 16, further comprising:
detecting that the measurement data includes at least one measurement value that is outside of a predefined range with a processor of the computing device or the remoter server; and
generating overlay data corresponding to a critical state graphic based on the at least one measurement value for rendering as the critical state graphic overlaid on the synthetic nonmedical on the display screen using a processor of the computing device.

20. The method as claimed in claim 16, further comprising:
generating the measurement data with a body-worn continuous glucose meter; and
transmitting the measurement data from the body-worn continuous glucose meter to the remote server using the computing device;
wherein the measurement data is representative of a blood glucose concentration over time.
